(19) United States
(12) Patent Application Publication
(10) Pub. No.: US 2025/0351129 A1
(43) Pub. Date: Nov. 13, 2025

(54) METHOD AND APPARATUS FOR TRANSMITTING SIDELINK RANGING SIGNAL

(71) Applicant: Beijing Xiaomi Mobile Software Co., Ltd., Beijing (CN)

(72) Inventor: Qun ZHAO, Beijing (CN)

(21) Appl. No.: 18/855,585

(22) PCT Filed: Apr. 11, 2022
(86) PCT No.: PCT/CN2022/086184

§ 371 Date: Oct. 9, 2024

(51) Int. Cl. H04W 72/0453; H04W 64/00; H04W 72/543

(52) U.S. Cl. CPC H04W 72/0453; H04W 64/00; H04W 72/543

(57) ABSTRACT

A method for transmitting a sidelink ranging signal. performed by a transmitting terminal device, includes: transmitting k ranging signals to a receiving terminal device in k times, wherein the k ranging signals respectively occupy different subband groups, at least one subband group contains an integer number of subbands, at least one subband contains a continuous frequency domain resource, and k is a positive integer greater than or equal to 1.

### CROSS-REFERENCE TO RELATED APPLICATION

The present application is a U.S. National Phase of International Patent Application Serial No. PCT/CN2022/086184 filed on Apr. 11, 2022. The contents of this application are hereby incorporated by reference in their entirety for all purposes.

### BACKGROUND OF THE INVENTION

There is an inverse relationship between the positioning accuracy of a positioning signal and a frequency domain bandwidth occupied by the positioning signal. Therefore, in order to obtain higher positioning accuracy, large-bandwidth positioning signals are required. On the other hand, the large-bandwidth positioning signals mean the occupancy of more frequency domain resources. Therefore, positioning signals are usually designed in the form of a frequency domain comb to simultaneously obtain large bandwidth and frequency domain multiplexing between different users.

### SUMMARY OF THE INVENTION

Embodiments of the present disclosure provide a method and an apparatus for updating a cell group of a dual-connected terminal device.

In a first aspect, an embodiment of the present disclosure provides a method for transmitting a sidelink ranging signal. The method is performed by a transmitting terminal device. The method includes: transmitting k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

In a second aspect, an embodiment of the present disclosure provides a method for transmitting a sidelink ranging signal. The method is performed by a receiving terminal device. The method includes: receiving, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1; and ranging and/or positioning the transmitting terminal device based on the k ranging signals.

In a third aspect, an embodiment of the present disclosure provides a communication apparatus. The communication apparatus includes one or more processors. When calling a computer program in a memory, the one or more processors performs the method according to the above first aspect.

In a fourth aspect, an embodiment of the present disclosure provides a communication apparatus. The communication apparatus includes one or more processors. When calling a computer program in a memory, the one or more processors performs the method according to the above second aspect.

In a fifth aspect, an embodiment of the present disclosure provides a communication apparatus. The communication apparatus includes one or more processors and a memory. The memory has a computer program stored therein. The one or more processors executes the computer program stored in the memory to cause the communication apparatus to perform the method according to the above first aspect.

In a sixth aspect, an embodiment of the present disclosure provides a communication apparatus. The communication apparatus includes one or more processors and a memory. The memory has a computer program stored therein. The one or more processors executes the computer program stored in the memory to cause the communication apparatus to perform the method according to the above second aspect.

In a seventh aspect, an embodiment of the present disclosure provides a communication apparatus. The apparatus includes one or more processors and an interface circuit. The interface circuit is configured to receive code instructions and transmit the code instructions to the one or more processors. The one or more processors is configured to run the code instructions to cause the apparatus to perform the method according to the above first aspect.

In an eighth aspect, an embodiment of the present disclosure provides a communication apparatus. The apparatus includes one or more processors and an interface circuit. The interface circuit is configured to receive code instructions and transmit the code instructions to the one or more processors. The one or more processors is configured to run the code instructions to cause the apparatus to perform the method according to the above second aspect.

In a ninth aspect, an embodiment of the present disclosure provides a system for transmitting a sidelink ranging signal. The system includes the communication apparatus according to the third aspect and the communication apparatus according to the fourth aspect, or the system includes the communication apparatus according to the fifth aspect and the communication apparatus according to the sixth aspect, or the system includes the communication apparatus according to the seventh aspect and the communication apparatus according to the eighth aspect.

In a tenth aspect, an embodiment of the present invention provides a non-transitory computer-readable storage medium, storing instructions to be executed by the above terminal device. The instructions, when executed by the terminal device, cause the terminal device to perform the method according the above first aspect.

In an eleventh aspect, an embodiment of the present invention provides a non-transitory readable storage medium, storing instructions to be executed by the above network device. The instructions, when executed by the above network device, cause the network device to perform the method according to the second aspect.

In a twelfth aspect, the present disclosure further provides a computer program product including a computer program. The computer program product, when run on a computer, causes the computer to perform the method according to the first aspect.

In a thirteenth aspect, the present disclosure further provides a computer program product including a computer program. The computer program product, when run on a computer, causes the computer to perform the method according to the second aspect.

In a fourteenth aspect, the present disclosure provides a chip system. The chip system includes at least one processor and an interface, to support a terminal device in implementing the functions involved in the first aspect, for example, determining or processing at least one of data and information involved in the method above. In a possible design, the chip system further includes a memory. The memory is configured to store a computer program and data necessary for the terminal device. The chip system may consist of chips, or include chips and other discrete devices.

In a fifteenth aspect, the present disclosure provides a chip system. The chip system includes at least one processor and an interface, to support a network device in implementing the functions involved in the second aspect, for example, determining or processing at least one of data and information involved in the method above. In a possible design, the chip system further includes a memory. The memory is configured to store a computer program and data necessary for the network device. The chip system may consist of chips, or include chips and other discrete devices.

In a sixteenth aspect, the present disclosure provides a computer program. The computer program, when run on a computer, causes the computer to perform the method according to the first aspect.

In a seventeenth aspect, the present disclosure provides a computer program. The computer program, when run on a computer, causes the computer to perform the method according to the second aspect.

### BRIEF DESCRIPTION OF DRAWINGS

In order to describe the technical solutions in embodiments of the present disclosure or in the background art more clearly, the accompanying drawings to be used in the embodiments of the present disclosure or in the background art are described below.

FIG. 1 is a schematic architectural diagram of a communication system provided in an embodiment of the present disclosure;

FIG. 2 is a schematic flowchart of a method for transmitting a sidelink ranging signal provided in an embodiment of the present disclosure;

FIG. 3 is a schematic flowchart of a method for transmitting a sidelink ranging signal provided in an embodiment of the present disclosure;

FIG. 4 is a schematic flowchart of a method for transmitting a sidelink ranging signal provided in an embodiment of the present disclosure;

FIG. 5 is a schematic flowchart of a method for transmitting a sidelink ranging signal provided in an embodiment of the present disclosure;

FIG. 6 is a schematic structural diagram of a communication apparatus provided in an embodiment of the present disclosure;

FIG. 7 is a schematic structural diagram of another communication apparatus provided in an embodiment of the present disclosure; and

FIG. 8 is a schematic structural diagram of a chip provided in an embodiment of the present disclosure.

### DETAILED DESCRIPTION OF THE INVENTION

The present disclosure relates to the technical field of communications, and in particular, to a method and an apparatus for transmitting a sidelink ranging signal.

There is an inverse relationship between the positioning accuracy of a positioning signal and a frequency domain bandwidth occupied by the positioning signal. Therefore, in order to obtain higher positioning accuracy, large-bandwidth positioning signals are required. On the other hand, the large-bandwidth positioning signals mean the occupancy of more frequency domain resources. Therefore, positioning signals are usually designed in the form of a frequency domain comb to simultaneously obtain large bandwidth and frequency domain multiplexing between different users.

However, for sidelink communication, the geographic locations of terminal devices cannot be pre-arranged. Due to the difference in proximity between the terminal devices, signal path losses of different transmitting terminal devices to a same receiving terminal device may differ greatly. Due to the existence of in-band emission, even if two different signals occupy different frequency domain positions, the strong signal may annihilate the weak one when the received power of the two signals differs greatly.

For ease of understanding, the terms involved in the present disclosure are first introduced.

### 1. Sidelink Communication

It is also referred to as device to device communication (DDC), and refers to direct communication between terminal devices without forwarding through a network.

### 2. Ranging Signal

It is also referred to as a positioning signal, and may be used for positioning or ranging a terminal device.

In order to better understand a method for updating a cell group of a dual-connected terminal device disclosed in an embodiment of the present disclosure, a communication system to which the embodiments of the present disclosure are applicable is first described below.

Referring to FIG. 1, FIG. 1 is a schematic architectural diagram of a communication system 100 provided in an embodiment of the present disclosure. The communication system 100 may include, but is not limited to, one network device and one terminal device. The number and form of the devices shown in FIG. 1 are merely for illustrative purpose and do not constitute a limitation on the embodiments of the present disclosure. In actual application, the communication system 100 may include two or more network devices, two or more auxiliary communication devices, and two or more terminal devices. The communication system 100 shown in FIG. 1 is exemplified by including one network device 11, one terminal device 12, and one terminal device 13.

It should be noted that, the technical solutions in the embodiments of the present disclosure may be applied to various communication systems, for example, a long term evolution (LTE) system, a 5th generation (5G) mobile communication system, a 5G new radio (NR) system, or other future new mobile communication systems.

The network device 11 in the embodiments of the present disclosure is an entity on a network side for transmitting or receiving a signal. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure do not limit the specific technologies and specific device forms used in the network device. The network device provided in the embodiments of the present disclosure may be formed by a central unit (CU) and a distributed unit (DU). The CU may also be referred to as a control unit. The adopting of the CU-DU structure may split protocol layers of the network device such as a base station. Functions of some protocol layers are placed in the CU for centralized control, and functions of some or all of the remaining protocol layers are distributed in the DU for centralized control of the DU by the CU.

The terminal device 12 and the terminal device 13 in the embodiments of the present disclosure are an entity on a user side for receiving or transmitting a signal, such as a mobile phone. A terminal device may also be referred to as a terminal, a user equipment (UE), a mobile station (MS), a mobile terminal (MT), or the like. The terminal device may be a car with a communication function, a smart car, a mobile phone, a wearable device, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technologies and the specific device forms used for the terminal device.

It may be understood that the communication system described in the embodiments of the present disclosure is to describe the technical solutions in the embodiments of the present disclosure more clearly, but does not constitute a limitation on the technical solutions provided in the embodiments of the present disclosure. A person of ordinary skill in the art may learn that, with the evolution of the system architecture and the emergence of new service scenarios, the technical solutions provided in the embodiments of the present disclosure are also applicable to similar technical problems.

Usually, a positioning signal transmitted by a terminal device in a cellular system requires uplink power control. Therefore, different positioning signals of a same frequency domain resource that are comb multiplexed by different terminal devices have approximately the same received power when received by the network device. Downlink signals are uniformly transmitted by the network device, so that the positioning signals of different terminal devices also have approximately the same received power when received by the terminal device. Due to the comb-multiplexing between the positioning signals of different terminal devices, the interference therebetween can be ignored.

However, for sidelink communication, the geographic locations of terminal devices cannot be prearranged. Due to the difference in proximity between the terminal devices, signal path losses of different transmitting terminal devices to a same receiving terminal device may differ greatly. Due to the existence of in-band emission, even if two different signals occupy different frequency domain positions, the strong signal may annihilate the weak one when the received power of the two signals differs greatly.

Generally, the magnitude of in-band emission is related to the size of an interval between frequency domain positions occupied by two signals. For two signals in a frequency domain comb arrangement, a frequency domain interval between the two signals is small, and the interference caused by in-band emission is relatively severe. Therefore, in the present disclosure, ranging signals are transmitted in a plurality of times to maximize a frequency domain interval between the ranging signals that are comb-multiplexed each time, thereby reducing the intensity of the strong signal annihilating the weak one.

Referring to FIG. 2, FIG. 2 is a schematic flowchart of a method for transmitting a sidelink ranging signal provided in an embodiment of the present disclosure. The method is performed by a transmitting terminal device. As shown in FIG. 2, the method may include, but is not limited to, the following steps:

Step 201, transmit k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

The ranging signals may be used for ranging or positioning, and may be generated using sequences. A common generation method using sequences includes generating ranging signals using different base sequences, or generating ranging signals using different cyclic shifts of a same base sequence.

In the present disclosure, in order to avoid the interference between the transmitted ranging signals and ranging signals transmitted by the remaining transmitting terminal devices in a frequency domain comb arrangement, the transmitting terminal device transmits a set of ranging signals in a plurality of times, and the ranging signal transmitted each time occupies only one subband group, so that intervals between a frequency domain position occupied by the ranging signal transmitted each time and frequency domain positions occupied by the ranging signals transmitted by the remaining transmitting terminal devices are as sufficiently large as possible, thereby reducing the interference between the ranging signals transmitted by different transmitting terminal devices.

In one embodiment, the integer number of subbands contained in each subband group may be continuous, to further ensure the centralized frequency domain positions occupied by the ranging signals transmitted by the transmitting terminal device and sufficiently large intervals between the centralized frequency domain positions and the frequency domain positions occupied by the ranging signals transmitted by the remaining transmitting terminal devices.

In one embodiment, the number of subbands contained in each subband group may be the same or different, which is not limited in the present disclosure.

In one embodiment, the transmitting terminal device may determine the number of subbands contained in each subband group according to a protocol agreement.

Alternatively, if the transmitting terminal device is not within the network device coverage, the transmitting terminal device may determine the number of subbands contained in each subband group based on pre-configured information. The pre-configured information is information pre-burned in the transmitting terminal device.

Alternatively, if the transmitting terminal device is within the network device coverage, the transmitting terminal device may determine the number of subbands contained in each subband group based on received configuration information and/or indication in downlink control information transmitted by a network device.

Alternatively, the transmitting terminal device may also determine the number of subbands contained in each subband group based on a QoS requirement of a ranging or positioning service. For example, if the positioning service has a high QoS requirement, the subband group may include a small number of subbands, so that the number of subbands spaced between different ranging signals is maximized, thereby ensuring no interference between different ranging signals.

In addition, the transmitting terminal device also needs to determine the number of frequency domain units contained in each subband and/or a frequency domain position of the subband before transmitting the ranging signals. The frequency domain units may be frequency domain resources in any unit, for example, may be physical resource blocks (PRBs), or resource elements (REs), etc., which is not limited in the present disclosure.

In one embodiment, the transmitting terminal device may determine the number of frequency domain units contained in each subband and/or the frequency domain position of the subband according to a protocol agreement.

Alternatively, if the transmitting terminal device is not within the network device coverage, the transmitting terminal device may determine the number of frequency domain units contained in each subband and/or the frequency domain position of the subband based on pre-configured information.

Alternatively, if the transmitting terminal device is within the network device coverage, the transmitting terminal device may determine the number of frequency domain units contained in each subband and/or the frequency domain position of the subband based on received configuration information and/or indication in downlink control information transmitted by a network device.

The frequency domain position of the subband may be a start frequency domain position of the subband, or an end frequency domain position of the subband, or an offset between the start frequency domain position of the subband and a start position of an available frequency domain bandwidth, etc., which is not limited in the present disclosure.

In order to ensure that each set of ranging signals occupy as wide a bandwidth as possible, frequency domain units between different subbands may not overlap each other.

In one embodiment, the transmitting terminal device may also first determine a frequency domain bandwidth available for the ranging signals and the number M of subbands, and then divide the frequency domain bandwidth available for the ranging signals into non-overlapping M continuous frequency domain resources, each of which is one subband.

For example, if M=10, the transmitting terminal device may divide the frequency domain bandwidth available for the ranging signals into 10 continuous frequency domain resources, each of which is one subband. The size of the 10 continuous frequency domain resources may be the same or different, which is not limited in the present disclosure.

In one embodiment, the transmitting terminal device may determine the frequency domain bandwidth available for the ranging signals according to a protocol agreement.

Alternatively, if the transmitting terminal device is not within the network device coverage, the transmitting terminal device may determine the frequency domain bandwidth available for the ranging signals based on pre-configured information.

Alternatively, if the transmitting terminal device is within the network device coverage, the transmitting terminal device may determine the frequency domain bandwidth available for the ranging signals based on received configuration information and/or indication in downlink control information transmitted by a network device.

In addition, the transmitting terminal device may determine the number M of subbands according to a protocol agreement.

Alternatively, if the transmitting terminal device is not within the network device coverage, the transmitting terminal device may also determine the number M of subbands based on pre-configured information.

Alternatively, if the transmitting terminal device is within the network device coverage, the transmitting terminal device may also determine the number M of subbands based on received configuration information and/or indication in downlink control information transmitted by a network device.

Further, after determining the number L of frequency domain units contained in a frequency domain bandwidth available for the k ranging signals and the number M of subbands, the transmitting terminal device may also determine the size of each subband through calculation.

For example, if (L/M) is an integer, it may be determined that the size of each subband is (L/M) frequency domain units.

Alternatively, if (L/M) is a non-integer, it may be determined that the size of each of x subbands is rounded up (L/M) frequency domain units, and the size of each of the remaining subbands is rounded down (L/M) frequency domain units, where x is the remainder of (L/M).

For example, if L=100 and M=9, it may be determined that the number of frequency domain units contained in one of the subbands is 12 and the number of frequency domain units contained in each of the remaining 8 subbands is 11.

Alternatively, if (L/M) is a non-integer, it is determined that the size of each of M−1 subbands is rounded up (L/M) frequency domain units, and the size of one remaining subband is the number of remaining frequency domain units in L frequency domain units. For example, if L=100 and M=9, it may be determined that the number of frequency domain units contained in 8 of the subbands is 12 and the number of frequency domain units contained in the remaining one subband is 4.

In addition, the number of ranging signals, i.e., the value of k, also affects the accuracy of ranging. When the value of k is larger, for example, the number of ranging signals is larger, if each ranging signal occupies a different frequency domain position, the ranging signals occupy wider frequency domain positions, resulting in higher accuracy of ranging. When the value of k is smaller, for example, the number of ranging signals is smaller, the ranging signals occupy narrower frequency domain positions, resulting in lower accuracy of ranging. Therefore, the transmitting terminal device may determine the value of k before transmitting the ranging signals.

In one embodiment, the transmitting terminal device may determine the value of k according to a protocol agreement.

Alternatively, if the transmitting terminal device is not within the network device coverage, the transmitting terminal device may determine the value of k based on pre-configured information.

Alternatively, if the transmitting terminal device is within the network device coverage, the transmitting terminal device may determine the value of k based on received configuration information and/or indication information in downlink control information transmitted by a network device.

Alternatively, the transmitting terminal device may determine the value of k based on a QoS requirement of a ranging or positioning service.

For example, if the ranging or positioning service has a high QoS requirement, a larger value of k may be determined, for example, the number of ranging signals may be increased, so that the plurality of ranging signals occupy wider frequency domain positions, thereby ensuring the accuracy of the ranging signals.

In one embodiment, the union of subband groups respectively occupied by the k ranging signals transmitted by the transmitting terminal device in k times is equal to a frequency domain bandwidth available for all ranging signals, causing wider frequency domain positions occupied by the k ranging signals, thereby ensuring the accuracy of ranging.

In the present disclosure, the transmitting terminal device may transmit k ranging signals to the receiving terminal device in k times. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

Referring to FIG. 3, FIG. 3 is a schematic flowchart of a method for transmitting a sidelink ranging signal provided in an embodiment of the present disclosure. The method is performed by a transmitting terminal device. As shown in FIG. 3, the method may include, but is not limited to, steps 301 and 302.

Step 301, determine a frequency domain position of the subband group corresponding to one of the ranging signals.

In the present disclosure, k subband groups may be comb-distributed in the frequency domain bandwidth available for the ranging signals, and the transmitting terminal device needs to determine the frequency domain position of the subband group corresponding to each ranging signal before transmitting the ranging signals, so that intervals between the frequency domain position occupied by the ranging signal transmitted each time and frequency domain positions occupied by ranging signals transmitted by the remaining transmitting terminal devices are as sufficiently large as possible, thereby reducing the interference between the ranging signals transmitted by different transmitting terminal devices. The frequency domain position of each subband group may be a frequency domain position of a start subband in the subband group, or a frequency domain position of an end subband in the subband group, etc., which is not limited in the present disclosure.

For example, if the frequency domain bandwidth available for the ranging signals corresponds to M subbands, when transmitting a ranging signal for the first time, the transmitting terminal device may transmit the ranging signal at the frequency domain position of the first subband, and another transmitting terminal device may transmit a ranging signal at the frequency domain position of the (M/2)^{th} subband, for example, M/2 subbands are spaced between the frequency domain positions occupied by the ranging signals transmitted by the two transmitting terminal devices, thereby reducing the interference between the ranging signals transmitted by the transmitting terminal devices.

In one embodiment, the transmitting terminal device may determine the frequency domain position of the subband group corresponding to the ranging signal according to a protocol agreement.

Alternatively, if the transmitting terminal device is not within the network device coverage, the transmitting terminal device may determine the frequency domain position of the subband group corresponding to the ranging signal based on pre-configured information.

Alternatively, if the transmitting terminal device is not within the network device coverage, the transmitting terminal device may determine the frequency domain position of the subband group corresponding to the ranging signal based on an indication of a network device.

In the present disclosure, the transmitting terminal device may determine frequency domain positions of k subband groups respectively corresponding to the k ranging signals; or may determine a frequency domain position of the first subband group in the k subband groups and frequency domain offsets between the remaining subband groups and the first subband group; or may determine frequency domain offsets respectively corresponding to k ranging signals transmitted at different transmitting times, etc., which is not limited in the present disclosure.

In one embodiment, the transmitting terminal device may also determine the frequency domain position of the subband group corresponding to the ranging signal based on the order of the ranging signal in the k ranging signals and a first offset. The first offset may be a frequency domain offset between frequency domain positions of start subbands in subband groups corresponding to adjacent ranging signals, etc., which is not limited in the present disclosure.

For example, if the first offset is set to offset, and a frequency domain position of a start subband of a ranging signal transmitted at the kth time is set to m(k), a frequency domain position of a start subband of a ranging signal transmitted at the (k+1)^{th} time is m(k+1)=mod(m(k)+offset, M), where M is a total number of subbands contained in the frequency domain bandwidth corresponding to the ranging signals, a resource pool, or a resource set.

For example, assuming that the first offset is 2 and M=5, index numbers of the subbands are 0, 1, 2, 3, and 4, respectively. If a start frequency domain position of a ranging signal transmitted for the first time is at a frequency domain position of the subband with index number 0, a start frequency domain position of a ranging signal transmitted for the second time is at a frequency domain position of the subband with index number 2, a start frequency domain position of a ranging signal transmitted for the third time is at a frequency domain position of the subband with index number 4, a start frequency domain position of a ranging signal transmitted for the fourth time is at a frequency domain position of the subband with index number 1, a start frequency domain position of a ranging signal transmitted for the fifth time is at a frequency domain position of the subband with index number 3, and start frequency domain positions of the ranging signals transmitted subsequently correspond to frequency domain positions of the subbands with cyclic index number {0, 2, 4, 1, 3}.

In one embodiment, the transmitting terminal device may also determine the frequency domain position of the subband group corresponding to the ranging signal based on a transmitting time position corresponding to the ranging signal and a second offset. The second offset may be a time interval between transmitting times corresponding to adjacent ranging signals, etc., which is not limited in the present disclosure.

In the present disclosure, each ranging signal may be transmitted at a corresponding transmitting time position, and each transmitting time position corresponds to a fixed frequency domain position. In this way, the transmitting terminal device may also determine the frequency domain position of the subband group corresponding to the ranging signal based on the second offset and the transmitting time position corresponding to the ranging signal. In addition, the transmitting time position may correspond to an available transmitting time length. Within the transmitting time length at the transmitting time position, the ranging signals may be transmitted. The transmitting time length may contain one or more symbols or slots.

Further, the transmitting terminal device may determine a transmitting time length corresponding to each ranging signal and/or a time interval between corresponding transmitting times of the ranging signal and an adjacent ranging signal according to a protocol agreement.

Alternatively, if the transmitting terminal device is not within the network device coverage, the transmitting terminal device may determine a transmitting time length corresponding to each ranging signal and/or a time interval between corresponding transmitting times of the ranging signal and an adjacent ranging signal based on pre-configured information.

Alternatively, if the transmitting terminal device is not within the network device coverage, the transmitting terminal device may determine a transmitting time length corresponding to each ranging signal and/or a time interval between corresponding transmitting times of the ranging signal and an adjacent ranging signal based on received configuration information and/or indication information in downlink control information transmitted by a network device.

In addition, the transmitting terminal device may determine the first offset and/or the second offset according to a protocol agreement.

Alternatively, if the transmitting terminal device is not within the network device coverage, the transmitting terminal device may determine the first offset and/or the second offset based on pre-configured information.

Alternatively, if the transmitting terminal device is within the network device coverage, the transmitting terminal device may determine the first offset and/or the second offset based on an indication of a network device.

Alternatively, the transmitting terminal device may also determine the first offset and/or the second offset based on a total frequency domain bandwidth available for the ranging signals.

For example, M is the total number of subbands contained in the total frequency domain bandwidth corresponding to the ranging signals, a resource pool, or a resources set. When M is odd, the offset may be (M/2) rounded up or (M/2) rounded down, and when M is even, the offset may be M/2+1 or M/2−1.

Alternatively, when the subband group occupied by the ranging signal transmitted by the transmitting terminal device is the same as the subband group occupied by the ranging signal transmitted by another transmitting terminal device, the ranging signals may be processed based on a sequence or cyclic shift different from that of the another transmitting terminal device.

Step 302, transmit k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

For the specific implementation process of step 302 in the present disclosure, reference may be made to the detailed description of any embodiment of the present disclosure. Details are not repeated herein.

In the present disclosure, the transmitting terminal device may transmit k ranging signals to the receiving terminal device in k times after determining the frequency domain positions of the subband groups corresponding to the ranging signals. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals transmitted, further improving the accuracy of ranging and/or positioning.

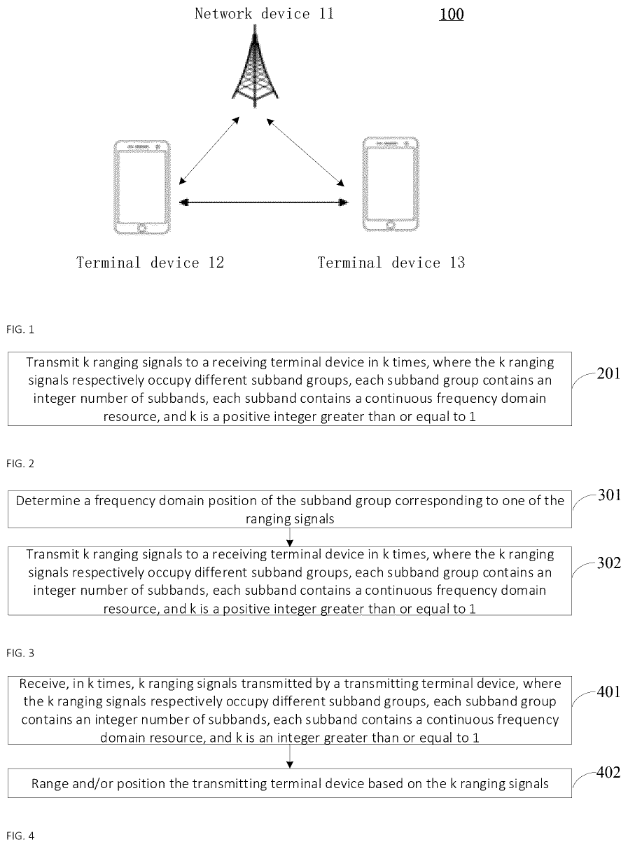

Referring to FIG. 4, FIG. 4 is a schematic flowchart of a method for transmitting a sidelink ranging signal provided in an embodiment of the present disclosure. The method is performed by a receiving terminal device. As shown in FIG. 4, the method may include, but is not limited to, steps 401 and 402.

Step 401, receive, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1.

The ranging signals may be used for ranging or positioning, and may be generated using sequences. A common generation method using sequences includes generating ranging signals using different base sequences, or generating ranging signals using different cyclic shifts of a same base sequence.

In the present disclosure, in order to avoid the interference between the transmitted ranging signals and ranging signals transmitted by the remaining transmitting terminal devices in a frequency domain comb arrangement, the transmitting terminal device transmits a set of ranging signals in a plurality of times, and the ranging signal transmitted each time occupies only one subband group, so that intervals between a frequency domain position occupied by the ranging signal transmitted each time and frequency domain positions occupied by the ranging signals transmitted by the remaining transmitting terminal devices are as sufficiently large as possible, thereby reducing the interference between the ranging signals transmitted by different transmitting terminal devices.

In one embodiment, the integer number of subbands contained in each subband group may be continuous, to further ensure the centralized frequency domain positions occupied by the ranging signals transmitted by the transmitting terminal device and sufficiently large intervals between the centralized frequency domain positions and the frequency domain positions occupied by the ranging signals transmitted by the remaining transmitting terminal devices.

In one embodiment, the number of subbands contained in each subband group may be the same or different, which is not limited in the present disclosure.

In contrast, the receiving terminal device may receive, in k times, k ranging signals transmitted by the transmitting terminal device. In order to ensure reliable receiving of ranging signals by the receiving terminal device, the receiving terminal device needs to determine the number of subbands contained in the subband group occupied by each ranging signal.

In one embodiment, the receiving terminal device may determine the number of subbands contained in each subband group according to a protocol agreement.

Alternatively, if the receiving terminal device is not within the network device coverage, the receiving terminal device may determine the number of subbands contained in each subband group based on pre-configured information. The pre-configured information is information pre-stored in the receiving terminal device.

Alternatively, if the receiving terminal device is within the network device coverage, the receiving terminal device may determine the number of subbands contained in each subband group based on received configuration information and/or indication in downlink control information transmitted by a network device.

Alternatively, the receiving terminal device may determine the number of subbands contained in each subband group based on a QoS requirement of a ranging or positioning service. For example, if the positioning service has a high QoS requirement, the subband group may include a small number of subbands, so that the number of subbands spaced between different ranging signals is maximized, thereby ensuring no interference between different ranging signals.

In addition, the receiving terminal device also needs to determine the number of frequency domain units contained in each subband and/or a frequency domain position of the subband before receiving the ranging signals transmitted by the transmitting terminal device. The frequency domain units may be frequency domain resources in any unit, for example, may be physical resource blocks (PRBs), or resource elements (REs), etc., which is not limited in the present disclosure.

In one embodiment, the receiving terminal device may determine the number of frequency domain units contained in each subband and/or the frequency domain position of the subband according to a protocol agreement.

Alternatively, if the receiving terminal device is not within the network device coverage, the receiving terminal device may determine the number of frequency domain units contained in each subband and/or the frequency domain position of the subband based on pre-configured information.

Alternatively, if the receiving terminal device is within the network device coverage, the receiving terminal device may determine the number of frequency domain units contained in each subband and/or the frequency domain position of the subband based on received configuration information and/or indication in downlink control information transmitted by a network device.

The frequency domain position of the subband may be a start frequency domain position of the subband, or an end frequency domain position of the subband, or an offset between the start frequency domain position of the subband and a start position of an available frequency domain bandwidth, etc., which is not limited in the present disclosure.

In order to ensure that each set of ranging signals occupy as wide a bandwidth as possible, frequency domain units between different subbands may not overlap each other.

In one embodiment, the receiving terminal device may also first determine a frequency domain bandwidth available for the ranging signals and the number M of subbands, and then divide the frequency domain bandwidth available for the ranging signals into non-overlapping M continuous frequency domain resources, each of which is one subband.

For example, if M=10, the receiving terminal device may divide the frequency domain bandwidth available for the ranging signals into 10 continuous frequency domain resources, each of which is one subband. The size of the 10 continuous frequency domain resources may be the same or different, which is not limited in the present disclosure.

In one embodiment, the receiving terminal device may determine the frequency domain bandwidth available for the ranging signals according to a protocol agreement.

Alternatively, if the receiving terminal device is not within the network device coverage, the receiving terminal device may also determine the frequency domain bandwidth available for the ranging signals based on pre-configured information.

Alternatively, if the receiving terminal device is within the network device coverage, the receiving terminal device may also determine the frequency domain bandwidth available for the ranging signals based on received configuration information and/or indication in downlink control information transmitted by a network device.

In addition, the receiving terminal device may determine the number M of subbands according to a protocol agreement.

Alternatively, if the receiving terminal device is not within the network device coverage, the receiving terminal device may also determine the number M of subbands based on pre-configured information.

Alternatively, if the receiving terminal device is within the network device coverage, the receiving terminal device may also determine the number M of subbands based on received configuration information and/or indication in downlink control information transmitted by a network device.

Further, after determining the number L of frequency domain units contained in a frequency domain bandwidth available for the k ranging signals and the number M of subbands, the receiving terminal device may also determine the size of each subband through calculation.

For example, if (L/M) is an integer, it may be determined that the size of each subband is (L/M) frequency domain units.

Alternatively, if (L/M) is a non-integer, it may be determined that the size of each of x subbands is rounded up (L/M) frequency domain units, and the size of each of the remaining subbands is rounded down (L/M) frequency domain units, where x is the remainder of (L/M).

For example, if L=100 and M=9, it may be determined that the number of frequency domain units contained in one of the subbands is 12 and the number of frequency domain units contained in each of the remaining 8 subbands is 11.

Alternatively, if (L/M) is a non-integer, it is determined that the size of each of M−1 subbands is rounded up (L/M) frequency domain units, and the size of one remaining subband is the number of remaining frequency domain units in L frequency domain units. For example, if L=100 and M=9, it may be determined that the number of frequency domain units contained in 8 of the subbands is 12 and the number of frequency domain units contained in the remaining one subband is 4.

In addition, the number of ranging signals, i.e., the value of k, also affects the accuracy of ranging. When the value of k is larger, for example, the number of ranging signals is larger, if each ranging signal occupies a different frequency domain position, the ranging signals occupy wider frequency domain positions, resulting in higher accuracy of ranging. When the value of k is smaller, for example, the number of ranging signals is smaller, the ranging signals occupy narrower frequency domain positions, resulting in lower accuracy of ranging. Therefore, the transmitting terminal device may determine the value of k before transmitting the ranging signals. Correspondingly, the receiving terminal device may determine the value of k before receiving the ranging signals transmitted by the transmitting terminal device to ensure reliable receiving of the ranging signals.

In one embodiment, the receiving terminal device may determine the value of k according to a protocol agreement.

Alternatively, if the receiving terminal device is not within the network device coverage, the receiving terminal device may determine the value of k based on pre-configured information.

Alternatively, if the receiving terminal device is within the network device coverage, the receiving terminal device may determine the value of k based on received configuration information and/or indication information in downlink control information transmitted by a network device.

Alternatively, the receiving terminal device may also determine the value of k based on a QoS requirement of a ranging or positioning service.

For example, if the ranging or positioning service has a high QoS requirement, a larger value of k may be determined, for example, the number of ranging signals may be increased, so that the plurality of ranging signals occupy wider frequency domain positions, thereby ensuring the accuracy of the ranging signals.

In one embodiment, the union of subband groups respectively occupied by the k ranging signals transmitted by the transmitting terminal device in k times is equal to a frequency domain bandwidth available for all ranging signals, causing wider frequency domain positions occupied by the k ranging signals, thereby ensuring the accuracy of ranging.

Step 402, range and/or position the transmitting terminal device based on the k ranging signals.

In the present disclosure, the receiving terminal device receives, in k times, k ranging signals transmitted by the transmitting terminal device, and may range and/or position the transmitting terminal device based on the k ranging signals. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

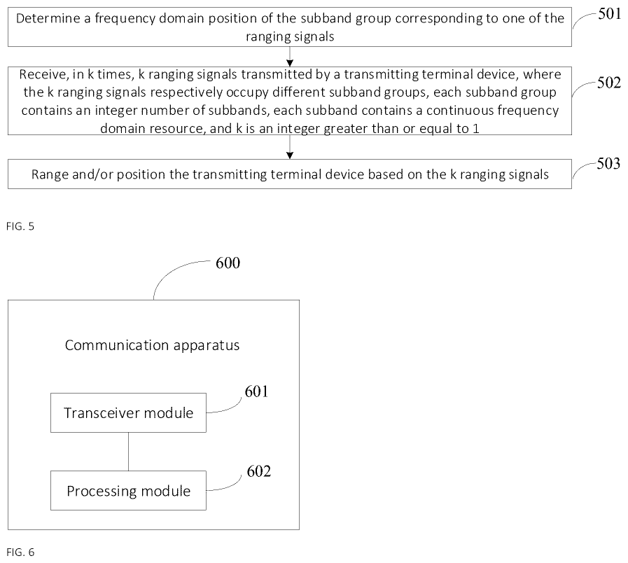

Referring to FIG. 5, FIG. 5 is a schematic flowchart of a method for transmitting a sidelink ranging signal according to an embodiment of the present disclosure. The method is performed by a receiving terminal device. As shown in FIG. 5, the method may include, but is not limited to, steps 501, 502 and 503.

Step 501, determine a frequency domain position of the subband group corresponding to one of the ranging signals.

In the present disclosure, k subband groups may be comb-distributed in the frequency domain bandwidth available for the ranging signals, and the transmitting terminal device needs to determine the frequency domain position of the subband group corresponding to each ranging signal before transmitting the ranging signals, so that intervals between the frequency domain position occupied by the ranging signal transmitted each time and frequency domain positions occupied by ranging signals transmitted by the remaining transmitting terminal devices are as sufficiently large as possible, thereby reducing the interference between the ranging signals transmitted by different transmitting terminal devices. The frequency domain position of each subband group may be a frequency domain position of a start subband in the subband group, or a frequency domain position of an end subband in the subband group, etc., which is not limited in the present disclosure.

For example, if the frequency domain bandwidth available for the ranging signals corresponds to M subbands, when transmitting a ranging signal for the first time, the transmitting terminal device may transmit the ranging signal at the frequency domain position of the first subband, and another transmitting terminal devices may transmit a ranging signal at the frequency domain position of the (M/2)^{th} subband, for example, M/2 subbands are spaced between the frequency domain positions occupied by the ranging signals transmitted by the two transmitting terminal devices, thereby reducing the interference between the ranging signals transmitted by different transmitting terminal devices.

In contrast, the receiving terminal device needs to determine a frequency domain position of the subband group corresponding to one of the ranging signals before receiving the ranging signals transmitted by the transmitting terminal device, to ensure reliable receiving of the ranging signals.

In one embodiment, the receiving terminal device may determine the frequency domain position of the subband group corresponding to the ranging signal according to a protocol agreement.

Alternatively, if the receiving terminal device is not within the network device coverage, the receiving terminal device may determine the frequency domain position of the subband group corresponding to the ranging signal based on pre-configured information.

Alternatively, if the receiving terminal device is not within the network device coverage, the receiving terminal device may determine the frequency domain position of the subband group corresponding to the ranging signal based on an indication of a network device.

In the present disclosure, the receiving terminal device may determine frequency domain positions of k subband groups respectively corresponding to the k ranging signals; or may determine a frequency domain position of the first subband group in the k subband groups and frequency domain offsets between the remaining subband groups and the first subband group; or may determine frequency domain offsets respectively corresponding to k ranging signals transmitted at different transmitting times, etc., which is not limited in the present disclosure.

In one embodiment, the receiving terminal device may also determine the frequency domain position of the subband group corresponding to the ranging signal based on the order of the ranging signal in the k ranging signals and a first offset. The first offset may be a frequency domain offset between frequency domain positions of start subbands in subband groups corresponding to adjacent ranging signals, etc., which is not limited in the present disclosure.

For example, if the first offset is set to offset, and a frequency domain position of a start subband of a ranging signal transmitted at the kth time is set to m(k), a frequency domain position of a start subband of a ranging signal transmitted at the (k+1)^{th} time is m(k+1)=mod (m(k)+offset, M), where M is a total number of subbands contained in the frequency domain bandwidth corresponding to the ranging signals, a resource pool, or a resource set.

For example, assuming that the first offset is 2 and M=5, index numbers of the subbands are 0, 1, 2, 3, and 4, respectively. If a start frequency domain position of a ranging signal transmitted for the first time is at a frequency domain position of the subband with index number 0, a start frequency domain position of a ranging signal transmitted for the second time is at a frequency domain position of the subband with index number 2, a start frequency domain position of a ranging signal transmitted for the third time is at a frequency domain position of the subband with index number 4, a start frequency domain position of a ranging signal transmitted for the fourth time is at a frequency domain position of the subband with index number 1, a start frequency domain position of a ranging signal transmitted for the fifth time is at a frequency domain position of the subband with index number 3, and start frequency domain positions of the ranging signals transmitted subsequently correspond to frequency domain positions of the subbands with cyclic index number {0, 2, 4, 1, 3}.

In one embodiment, the receiving terminal device may also determine the frequency domain position of the subband group corresponding to the ranging signal based on a transmitting time position corresponding to the ranging signal and a second offset. The second offset may be a time interval between transmitting times corresponding to adjacent ranging signals, etc., which is not limited in the present disclosure.

In the present disclosure, each ranging signal may be transmitted at a corresponding transmitting time position, and each transmitting time position corresponds to a fixed frequency domain position. In this way, the receiving terminal device may also determine the frequency domain position of the subband group corresponding to the ranging signal based on the second offset and the transmitting time position corresponding to the ranging signal. In addition, the transmitting time position may correspond to an available transmitting time length. Within the transmitting time length at the transmitting time position, the ranging signals may be transmitted. The transmitting time length may contain one or more symbols or slots.

Further, the receiving terminal device may determine a transmitting time length corresponding to each ranging signal and/or a time interval between corresponding transmitting times of the ranging signal and an adjacent ranging signal according to a protocol agreement.

Alternatively, if the receiving terminal device is not within the network device coverage, the receiving terminal device may determine a transmitting time length corresponding to each ranging signal and/or a time interval between corresponding transmitting times of the ranging signal and an adjacent ranging signal based on pre-configured information.

Alternatively, if the receiving terminal device is not within the network device coverage, the receiving terminal device may determine a transmitting time length corresponding to each ranging signal and/or a time interval between corresponding transmitting times of the ranging signal and an adjacent ranging signal based on received configuration information and/or indication information in downlink control information transmitted by a network device.

In addition, the receiving terminal device may determine the first offset and/or the second offset according to a protocol agreement.

Alternatively, if the receiving terminal device is not within the network device coverage, the receiving terminal device may determine the first offset and/or the second offset based on pre-configured information.

Alternatively, if the receiving terminal device is within the network device coverage, the receiving terminal device may determine the first offset and/or the second offset based on an indication of a network device.

Alternatively, the receiving terminal device may also determine the first offset and/or the second offset based on a total frequency domain bandwidth available for the ranging signals.

For example, M is the total number of subbands contained in the total frequency domain bandwidth corresponding to the ranging signals, a resource pool, or a resources set. When M is odd, the offset may be (M/2) rounded up or (M/2) rounded down, and when M is even, the offset may be M/2+1 or M/2−1.

Step 502, receive, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1.

Step 503, range and/or position the transmitting terminal device based on the k ranging signals.

For the specific implementation processes of step 502 to step 503 in the present disclosure, reference may be made to the detailed description of any embodiment of the present disclosure. Details are not repeated herein.

In the present disclosure, the receiving terminal device may receive, in k times, k ranging signals transmitted by the transmitting terminal device after determining the frequency domain positions of the subband groups corresponding to the ranging signals, and then range and/or position the transmitting terminal device based on the k ranging signals. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

Referring to FIG. 6, FIG. 6 is a schematic structural diagram of a communication apparatus 600 provided in an embodiment of the present disclosure. The communication apparatus 600 shown in FIG. 6 may include a processing module 601 and a transceiver module 602. The transceiver module 602 may include a transmitting module and/or a receiving module. The transmitting module is configured to implement a transmitting function, and the receiving module is configured to implement a receiving function. The transceiver module 602 may implement a transmitting function and/or a receiving function.

It may be understood that the communication apparatus 600 may be a transmitting terminal device, an apparatus in the transmitting terminal device, or an apparatus capable of being used with the transmitting terminal device.

The communication apparatus 600 is on a transmitting terminal device side.

The transceiver module 602 is configured to transmit k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

In one embodiment, the apparatus further includes a processing module 601, configured to:
determine the number of frequency domain units contained in each subband and/or a frequency domain position of the subband according to a protocol agreement; or
determine the number of frequency domain units contained in each subband and/or a frequency domain position of the subband based on pre-configured information; or
determine the number of frequency domain units contained in each subband and/or a frequency domain position of the subband based on received configuration information and/or indication information in downlink control information transmitted by a network device,
where frequency domain units between different subbands do not overlap each other.

In one embodiment, the processing module 601 is further configured to:
determine a frequency domain bandwidth available for the ranging signals;
determine the number M of subbands; and
divide the frequency domain bandwidth available for the ranging signals into non-overlapping M continuous frequency domain resources, each of which is one subband.

In one embodiment, the processing module 601 is configured to:
determine the frequency domain bandwidth available for the ranging signals according to a protocol agreement; or
determine the frequency domain bandwidth available for the ranging signals based on pre-configured information; or
determine the frequency domain bandwidth available for the ranging signals based on received configuration information and/or indication information in downlink control information transmitted by a network device.

In one embodiment, the processing module 601 is configured to:
determine the number M of the subbands according to a protocol agreement; or
determine the number M of the subbands based on pre-configured information; or
determine the number M of the subbands based on received configuration information and/or indication information in downlink control information transmitted by a network device.

In one embodiment, the processing module 601 is further configured to:
if (L/M) is an integer, determine that the size of each subband is (L/M) frequency domain units; or
if (L/M) is a non-integer, determine that the size of each of x subbands is rounded up (L/M) frequency domain units, and the size of each of the remaining subbands is rounded down (L/M) frequency domain units, where x is the remainder of (L/M); or
if (L/M) is a non-integer, determine that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the processing module 601 is further configured to:
determine the number of subbands contained in each subband group according to a protocol agreement; or
determine the number of subbands contained in each subband group based on pre-configured information; or
determine the number of subbands contained in each subband group based on received configuration information and/or indication information in downlink control information transmitted by a network device; or
determine the number of subbands contained in each subband group based on a QoS requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the processing module 601 is further configured to:
determine a frequency domain position of the subband group corresponding to one of the ranging signals.

In one embodiment, the processing module 601 is configured to:
determine the frequency domain position of the subband group corresponding to the ranging signal based on the order of the ranging signal in the k ranging signals and a first offset; or
determine the frequency domain position of the subband group corresponding to the ranging signal based on a transmitting time position corresponding to the ranging signal and a second offset; or
determine the frequency domain position of the subband group corresponding to the ranging signal according to a protocol agreement; or
determine the frequency domain position of the subband group corresponding to the ranging signal based on pre-configured information; or
determine the frequency domain position of the subband group corresponding to the ranging signal based on an indication of a network device.

In one embodiment, the processing module 601 is further configured to:
determine the first offset and/or the second offset according to a protocol agreement; or
determine the first offset and/or the second offset based on pre-configured information; or
determine the first offset and/or the second offset based on an indication of a network device; or
determine the first offset and/or the second offset based on a total frequency domain bandwidth available for the ranging signals.

In one embodiment, the processing module 601 is further configured to:
process the ranging signals based on a sequence or cyclic shift different from that of another transmitting terminal device, where a ranging signal transmitted by the transmitting terminal device occupies the same subband group as a ranging signal transmitted by the another transmitting terminal device.

In one embodiment, the processing module 601 is further configured to:
determine a transmitting time length corresponding to each ranging signal and/or a time interval between corresponding transmitting times of the ranging signal and an adjacent ranging signal according to a protocol agreement; or
determine a transmitting time length corresponding to each ranging signal and/or a time interval between corresponding transmitting times of the ranging signal and an adjacent ranging signal based on pre-configured information; or
determine a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the processing module 601 is further configured to:
determine the value of k according to a protocol agreement; or
determine the value of k based on pre-configured information; or
determine the value of k based on received configuration information and/or indication information in downlink control information transmitted by a network device; or
determine the value of k based on a QoS requirement of a ranging or positioning service.

In the present disclosure, the transmitting terminal device may transmit k ranging signals to the receiving terminal device in k times. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

It may be understood that the communication apparatus 600 may be a receiving terminal device, an apparatus in the receiving terminal device, or an apparatus capable of being used with the receiving terminal device.

The communication apparatus 600 is on a receiving terminal device side.

The transceiver module 602 is configured to receive, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1.

The processing module 601 is configured to range and/or position the transmitting terminal device based on the k ranging signals.

In one embodiment, the processing module 601 is further configured to:
determine the number of frequency domain units contained in each subband and/or a frequency domain position of the subband according to a protocol agreement; or
determine the number of frequency domain units contained in each subband and/or a frequency domain position of the subband based on pre-configured information; or
determine the number of frequency domain units contained in each subband and/or a frequency domain position of the subband based on received configuration information and/or indication information in downlink control information transmitted by a network device,
where frequency domain units between different subbands do not overlap each other.

In one embodiment, the processing module 601 is further configured to:
determine a frequency domain bandwidth available for the ranging signals;
determine the number M of subbands; and
divide the frequency domain bandwidth available for the ranging signals into non-overlapping M continuous frequency domain resources, each of which is one subband.

In one embodiment, the processing module 601 is configured to:
determine the frequency domain bandwidth available for the ranging signals according to a protocol agreement; or
determine the frequency domain bandwidth available for the ranging signals based on pre-configured information; or
determine the frequency domain bandwidth available for the ranging signals based on received configuration information and/or indication information in downlink control information transmitted by a network device.

In one embodiment, the processing module 601 is configured to:
determine the number M of the subbands according to a protocol agreement; or
determine the number M of the subbands based on pre-configured information; or
determine the number M of the subbands based on received configuration information and/or indication information in downlink control information transmitted by a network device.

In one embodiment, the processing module 601 is further configured to:
if (L/M) is an integer, determine that the size of each subband is (L/M) frequency domain units; or
if (L/M) is a non-integer, determine that the size of each of x subbands is rounded up (L/M) frequency domain units, and the size of each of the remaining subbands is rounded down (L/M) frequency domain units, where x is the remainder of (L/M); or
if (L/M) is a non-integer, determine that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the processing module 601 is further configured to:
determine the number of subbands contained in each subband group according to a protocol agreement; or
determine the number of subbands contained in each subband group based on pre-configured information; or
determine the number of subbands contained in each subband group based on received configuration information and/or indication information in downlink control information transmitted by a network device; or
determine the number of subbands contained in each subband group based on a QoS requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the processing module 601 is further configured to:
determine a frequency domain position of the subband group corresponding to one of the ranging signals.

In one embodiment, the processing module 601 is further configured to:
determine the frequency domain position of the subband group corresponding to the ranging signal based on the order of the ranging signal in the k ranging signals and a first offset; or
determine the frequency domain position of the subband group corresponding to the ranging signal based on a transmitting time position corresponding to the ranging signal and a second offset; or
determine the frequency domain position of the subband group corresponding to the ranging signal according to a protocol agreement; or
determine the frequency domain position of the subband group corresponding to the ranging signal based on pre-configured information; or
determine the frequency domain position of the subband group corresponding to the ranging signal based on an indication of a network device.

In one embodiment, the processing module 601 is further configured to:
determine the first offset and/or the second offset according to a protocol agreement; or
determine the first offset and/or the second offset based on pre-configured information; or
determine the first offset and/or the second offset based on an indication of a network device; or
determine the first offset and/or the second offset based on a total frequency domain bandwidth available for the ranging signals.

In one embodiment, the processing module 601 is further configured to:
determine a transmitting time length corresponding to each ranging signal and/or a time interval between corresponding transmitting times of the ranging signal and an adjacent ranging signal according to a protocol agreement; or
determine a transmitting time length corresponding to each ranging signal and/or a time interval between corresponding transmitting times of the ranging signal and an adjacent ranging signal based on pre-configured information; or
determine a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the processing module 601 is further configured to:
determine the value of k according to a protocol agreement; or
determine the value of k based on pre-configured information; or
determine the value of k based on received configuration information and/or indication information in downlink control information transmitted by a network device; or
determine the value of k based on a QoS requirement of a ranging or positioning service.

In the present disclosure, the receiving terminal device receives, in k times, k ranging signals transmitted by the transmitting terminal device, and may range and/or position the transmitting terminal device based on the k ranging signals. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

Referring to FIG. 7, FIG. 7 is a schematic structural diagram of another communication apparatus 700 provided in an embodiment of the present disclosure. The communication apparatus 700 may be a network device, or a terminal device, or a chip, chip system, or processor, etc. that supports the network device to implement the above method, or a chip, chip system, or processor, etc. that supports a terminal device to implement the above method. The apparatus may be configured to implement the method described in the above method embodiments. For details, reference may be made to the above method embodiments.

The communication apparatus 700 may include one or more processors 701. The processor 701 may be a general-purpose processor or a dedicated processor, etc., for example, a baseband processor or a central processing unit. The baseband processor may be configured to process a communication protocol and communication data. The central processing unit may be configured to control the communication apparatus (for example, base station, baseband chip, terminal device, terminal device chip, DU or CU, etc.), execute a computer program, and process data of the computer program.

In one embodiment, the communication apparatus 700 may further include one or more memories 702 on which a computer program 704 may be stored. The processor 701 executes the computer program 704 to cause the communication apparatus 700 to perform the method described in the above method embodiments. In one embodiment, the memory 702 may also have data stored therein. The communication apparatus 700 and the memory 702 may be arranged separately or integrated together.

In one embodiment, the communication apparatus 700 may further include a transceiver 705 and an antenna 706. The transceiver 705 may be referred to as a transceiver unit, a transceiver machine, or a transceiver circuit, etc. to implement a transceiver function. The transceiver 705 may include a receiver and a transmitter. The receiver may be referred to as a receiver machine, or a receiver circuit, etc. to implement a receiving function, and the transmitter may be referred to as a transmitter machine, or a transmitter circuit, etc. to implement a transmitting function.

In one embodiment, the communication apparatus 700 may further include one or more interface circuits 707. The interface circuit 707 is configured to receive code instructions and transmit the code instructions to the processor 701. The processor 701 runs the code instructions to cause the communication apparatus 700 to perform the method described in the above method embodiments.

If the communication apparatus 700 is a transmitting terminal device, the transceiver 705 performs step 201 in FIG. 2, step 302 in FIG. 3, etc.

If the communication apparatus 700 is a receiving terminal device, the processor 701 is configured to perform step 402 in FIG. 4, step 503 in FIG. 5, etc.

In an implementation, the processor 701 may include a transceiver configured to implement receiving and transmitting functions. For example, the transceiver may be a transceiver circuit, or interface, or interface circuit. The transceiver circuit, interface, or interface circuit configured to implement the receiving and transmitting functions may be arranged separately or integrated together. The transceiver circuit, interface, or interface circuit may be configured to read and write code/data, or the transceiver circuit, interface, or interface circuit may be configured to transmit or transfer a signal.

In an implementation, the processor 701 may store a computer program 703. The computer program 703 may be run on the processor 701 to cause the communication apparatus 700 to perform the method described in the above method embodiments. The computer program 703 may be solidified in the processor 701. In this case, the processor 701 may be implemented by hardware.

In an implementation, the communication apparatus 700 may include a circuit. The circuit may implement the function of transmitting, receiving, or communicating in the above method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), and gallium arsenide (GaAs).

The communication apparatus described in the above embodiments may be a network device, a terminal device, or an auxiliary communication device, but the scope of the communication apparatus described in the present disclosure is not limited thereto, and the structure of the communication apparatus may not be limited by FIG. 7. The communication apparatus may be an independent device or may be part of a larger device. For example, the communication apparatus may be:
(1) an independent integrated circuit (IC), or chip, or chip system or subsystem;
(2) a set of one or more ICs, where In one embodiment, the set of ICs may further include storage components for storing data and computer programs;
(3) an ASIC, such as a modem;
(4) a module that can be embedded in other devices;
(5) a receiver, a terminal device, an intelligent terminal device, a cellular phone, a wireless device, a handheld device, a mobile unit, an in-vehicle device, a network device, a cloud device, an artificial intelligence device, etc.; or
(6) others and so on.

For the case where the communication apparatus may be a chip or a chip system, reference may be made to the schematic structural diagram of a chip shown in FIG. 8. The chip shown in FIG. 8 includes a processor 801 and an interface 803. The number of processors 801 may be one or more, and the number of interfaces 803 may be more than one.

For the case where the chip is configured to implement the functions of the transmitting terminal device in the embodiments of the present disclosure:
the interface 803 is configured to perform step 201 in FIG. 2, step 301 in FIG. 3, etc.

For the case where the chip is configured to implement the functions of the receiving terminal device in the embodiments of the present disclosure:
the interface 803 is configured to perform step 401 in FIG. 4, step 501 and step 502 in FIG. 5, etc.

In one embodiment, the chip further includes a memory 803 configured to store necessary computer programs and data.

A person skilled in the art may also understand that various illustrative logical blocks and steps listed in the embodiments of the present disclosure may be implemented by electronic hardware, computer software, or a combination thereof. Whether such functions are implemented by hardware or software depends on the specific application and design requirements of the whole system. A person skilled in the art may use various methods to implement the described functions for each specific application, but such implementation should not be understood as exceeding the protection scope of the embodiments of the present disclosure.

The present disclosure also provides a non-transitory readable storage medium on which instructions are stored. The instructions, when executed by a computer, implement the function of any one of the above method embodiments.

The present disclosure also provides a computer program product. The computer program product, when executed by a computer, implements the function of any one of the above method embodiments.

Embodiments of the present disclosure provide a method and an apparatus for updating a cell group of a dual-connected terminal device.

In a first aspect, an embodiment of the present disclosure provides a method for transmitting a sidelink ranging signal. The method is performed by a transmitting terminal device. The method includes:
transmitting k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

In the present disclosure, the transmitting terminal device may transmit k ranging signals to the receiving terminal device in k times. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

In one embodiment, the method further includes:
determining the number of frequency domain units contained in each subband and/or a frequency domain position of the subband according to a protocol agreement; or
determining the number of frequency domain units contained in each subband and/or a frequency domain position of the subband based on pre-configured information; or
determining the number of frequency domain units contained in each subband and/or a frequency domain position of the subband based on received configuration information and/or indication information in downlink control information transmitted by a network device,
where frequency domain units between different subbands do not overlap each other.

In one embodiment, the method further includes:
determining a frequency domain bandwidth available for the ranging signals;
determining the number M of subbands; and
dividing the frequency domain bandwidth available for the ranging signals into non-overlapping M continuous frequency domain resources, each of which is one subband.

In one embodiment, the determining a frequency domain bandwidth available for the ranging signals includes:
determining the frequency domain bandwidth available for the ranging signals according to a protocol agreement; or
determining the frequency domain bandwidth available for the ranging signals based on pre-configured information; or
determining the frequency domain bandwidth available for the ranging signals based on received configuration information and/or indication information in downlink control information transmitted by a network device.

In one embodiment, the determining the number M of subbands includes:
determining the number M of the subbands according to a protocol agreement; or
determining the number M of the subbands based on pre-configured information; or
determining the number M of the subbands based on received configuration information and/or indication information in downlink control information transmitted by a network device.

In one embodiment, the method further includes:
in response to (L/M) being an integer, determining that the size of each subband is (L/M) frequency domain units; or
in response to (L/M) being a non-integer, determining that the size of each of x subbands is rounded up (L/M) frequency domain units, and the size of each of the remaining subbands is rounded down (L/M) frequency domain units, where x is the remainder of (L/M); or
in response to (L/M) being a non-integer, determining that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the method further includes:
determining the number of subbands contained in each subband group according to a protocol agreement; or
determining the number of subbands contained in each subband group based on pre-configured information; or
determining the number of subbands contained in each subband group based on received configuration information and/or indication information in downlink control information transmitted by a network device; or
determining the number of subbands contained in each subband group based on a Quality of Service (QOS) requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the method further includes:
determining a frequency domain position of the subband group corresponding to one of the ranging signals.

In one embodiment, the determining a frequency domain position of the subband group corresponding to one of the ranging signals includes:
determining the frequency domain position of the subband group corresponding to the ranging signal based on the order of the ranging signal in the k ranging signals and a first offset; or
determining the frequency domain position of the subband group corresponding to the ranging signal based on a transmitting time position corresponding to the ranging signal and a second offset; or
determining the frequency domain position of the subband group corresponding to the ranging signal according to a protocol agreement; or
determining the frequency domain position of the subband group corresponding to the ranging signal based on pre-configured information; or
determining the frequency domain position of the subband group corresponding to the ranging signal based on an indication of a network device.

In one embodiment, the method further includes:
determining the first offset and/or the second offset according to a protocol agreement; or
determining the first offset and/or the second offset based on pre-configured information; or
determining the first offset and/or the second offset based on an indication of a network device; or
determining the first offset and/or the second offset based on a total frequency domain bandwidth available for the ranging signals.

In one embodiment, the method further includes:
processing the ranging signals based on a sequence or cyclic shift different from that of another transmitting terminal device, where a ranging signal transmitted by the transmitting terminal device occupies the same subband group as a ranging signal transmitted by the another transmitting terminal device.

In one embodiment, the method further includes:
determining a transmitting time length corresponding to each ranging signal and/or a time interval between corresponding transmitting times of the ranging signal and an adjacent ranging signal according to a protocol agreement; or
determining a transmitting time length corresponding to each ranging signal and/or a time interval between corresponding transmitting times of the ranging signal and an adjacent ranging signal based on pre-configured information; or
determining a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the method further includes:
determining the value of k according to a protocol agreement; or
determining the value of k based on pre-configured information; or
determining the value of k based on received configuration information and/or indication information in downlink control information transmitted by a network device; or
determining the value of k based on a QoS requirement of a ranging or positioning service.

In a second aspect, an embodiment of the present disclosure provides a method for transmitting a sidelink ranging signal. The method is performed by a receiving terminal device. The method includes:
receiving, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1; and
ranging and/or positioning the transmitting terminal device based on the k ranging signals.

In the present disclosure, the receiving terminal device receives, in k times, k ranging signals transmitted by the transmitting terminal device, and may range and/or position the transmitting terminal device based on the k ranging signals. In this way, a set of ranging signals are transmitted in a plurality of times, and the ranging signal transmitted each time occupies only one subband group, so that intervals between a frequency domain position occupied by the ranging signal transmitted each time and frequency domain positions occupied by ranging signals transmitted by the remaining transmitting terminal devices are sufficiently large, thereby reducing the interference between different ranging signals, further improving the accuracy of ranging and/or positioning.

In one embodiment, the method further includes:
determining the number of frequency domain units contained in each subband and/or a frequency domain position of the subband according to a protocol agreement; or
determining the number of frequency domain units contained in each subband and/or a frequency domain position of the subband based on pre-configured information; or
determining the number of frequency domain units contained in each subband and/or a frequency domain position of the subband based on received configuration information and/or indication information in downlink control information transmitted by a network device,
where frequency domain units between different subbands do not overlap each other.

In one embodiment, the method further includes:
determining a frequency domain bandwidth available for the ranging signals;
determining the number M of subbands; and
dividing the frequency domain bandwidth available for the ranging signals into non-overlapping M continuous frequency domain resources, each of which is one subband.

In one embodiment, the determining a frequency domain bandwidth available for the ranging signals includes:
determining the frequency domain bandwidth available for the ranging signals according to a protocol agreement; or
determining the frequency domain bandwidth available for the ranging signals based on pre-configured information; or
determining the frequency domain bandwidth available for the ranging signals based on received configuration information and/or indication information in downlink control information transmitted by a network device.

In one embodiment, the determining the number M of subbands includes:
determining the number M of the subbands according to a protocol agreement; or
determining the number M of the subbands based on pre-configured information; or
determining the number M of the subbands based on received configuration information and/or indication information in downlink control information transmitted by a network device.

In one embodiment, the method further includes:
in response to (L/M) being an integer, determining that the size of each subband is (L/M) frequency domain units; or
in response to (L/M) being a non-integer, determining that the size of each of x subbands is rounded up (L/M) frequency domain units, and the size of each of the remaining subbands is rounded down (L/M) frequency domain units, where x is the remainder of (L/M); or
in response to (L/M) being a non-integer, determining that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the method further includes:
determining the number of subbands contained in each subband group according to a protocol agreement; or
determining the number of subbands contained in each subband group based on pre-configured information; or
determining the number of subbands contained in each subband group based on received configuration information and/or indication information in downlink control information transmitted by a network device; or
determining the number of subbands contained in each subband group based on a QoS requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the method further includes:
determining a frequency domain position of the subband group corresponding to one of the ranging signals.

In one embodiment, the determining a frequency domain position of the subband group corresponding to one of the ranging signals includes:
determining the frequency domain position of the subband group corresponding to the ranging signal based on the order of the ranging signal in the k ranging signals and a first offset; or
determining the frequency domain position of the subband group corresponding to the ranging signal based on a transmitting time position corresponding to the ranging signal and a second offset; or
determining the frequency domain position of the subband group corresponding to the ranging signal according to a protocol agreement; or
determining the frequency domain position of the subband group corresponding to the ranging signal based on pre-configured information; or
determining the frequency domain position of the subband group corresponding to the ranging signal based on an indication of a network device.

In one embodiment, the method further includes:
determining the first offset and/or the second offset according to a protocol agreement; or
determining the first offset and/or the second offset based on pre-configured information; or
determining the first offset and/or the second offset based on an indication of a network device; or
determining the first offset and/or the second offset based on a total frequency domain bandwidth available for the ranging signals.

In one embodiment, the method further includes:
determining a transmitting time length corresponding to each ranging signal and/or a time interval between corresponding transmitting times of the ranging signal and an adjacent ranging signal according to a protocol agreement; or
determining a transmitting time length corresponding to each ranging signal and/or a time interval between corresponding transmitting times of the ranging signal and an adjacent ranging signal based on pre-configured information; or
determining a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the method further includes:
determining the value of k according to a protocol agreement; or
determining the value of k based on pre-configured information; or
determining the value of k based on received configuration information and/or
indication information in downlink control information transmitted by a network device; or
determining the value of k based on a QoS requirement of a ranging or positioning service.

In a third aspect, an embodiment of the present disclosure provides a communication apparatus. On a transmitting terminal device side, the apparatus includes:
a transceiver module, configured to transmit k ranging signals to a receiving terminal device in k times, where the k ranging signals respectively occupy different subband groups, each subband group contains an integer number of subbands, each subband contains a continuous frequency domain resource, and k is a positive integer greater than or equal to 1.

In one embodiment, the apparatus further includes a processing module, configured to:
determine the number of frequency domain units contained in each subband and/or a frequency domain position of the subband according to a protocol agreement; or
determine the number of frequency domain units contained in each subband and/or a frequency domain position of the subband based on pre-configured information; or
determine the number of frequency domain units contained in each subband and/or a frequency domain position of the subband based on received configuration information and/or indication information in downlink control information transmitted by a network device,
where frequency domain units between different subbands do not overlap each other.

In one embodiment, the processing module is further configured to:
determine a frequency domain bandwidth available for the ranging signals;
determine the number M of subbands; and
divide the frequency domain bandwidth available for the ranging signals into non-overlapping M continuous frequency domain resources, each of which is one subband.

In one embodiment, the processing module is configured to:
determine the frequency domain bandwidth available for the ranging signals according to a protocol agreement; or
determine the frequency domain bandwidth available for the ranging signals based on pre-configured information; or
determine the frequency domain bandwidth available for the ranging signals based on received configuration information and/or indication information in downlink control information transmitted by a network device.

In one embodiment, the processing module is configured to:
determine the number M of the subbands according to a protocol agreement; or
determine the number M of the subbands based on pre-configured information; or
determine the number M of the subbands based on received configuration information and/or indication information in downlink control information transmitted by a network device.

In one embodiment, the processing module is further configured to:
in response to (L/M) being an integer, determine that the size of each subband is (L/M) frequency domain units; or
in response to (L/M) being a non-integer, determine that the size of each of x subbands is rounded up (L/M) frequency domain units, and the size of each of the remaining subbands is rounded down (L/M) frequency domain units, where x is the remainder of (L/M); or
in response to (L/M) being a non-integer, determine that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the processing module is further configured to:
determine the number of subbands contained in each subband group according to a protocol agreement; or
determine the number of subbands contained in each subband group based on pre-configured information; or
determine the number of subbands contained in each subband group based on received configuration information and/or indication information in downlink control information transmitted by a network device; or
determine the number of subbands contained in each subband group based on a QoS requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the processing module is further configured to:
determine a frequency domain position of the subband group corresponding to one of the ranging signals.

In one embodiment, the processing module is configured to:
determine the frequency domain position of the subband group corresponding to the ranging signal based on the order of the ranging signal in the k ranging signals and a first offset; or
determine the frequency domain position of the subband group corresponding to the ranging signal based on a transmitting time position corresponding to the ranging signal and a second offset; or
determine the frequency domain position of the subband group corresponding to the ranging signal according to a protocol agreement; or
determine the frequency domain position of the subband group corresponding to the ranging signal based on pre-configured information; or
determine the frequency domain position of the subband group corresponding to the ranging signal based on an indication of a network device.

In one embodiment, the processing module is further configured to:
determine the first offset and/or the second offset according to a protocol agreement; or
determine the first offset and/or the second offset based on pre-configured information; or
determine the first offset and/or the second offset based on an indication of a network
device; or
determine the first offset and/or the second offset based on a total frequency domain bandwidth available for the ranging signals.

In one embodiment, the processing module is further configured to:
process the ranging signals based on a sequence or cyclic shift different from that of another transmitting terminal device, where a ranging signal transmitted by the transmitting terminal device occupies the same subband group as a ranging signal transmitted by the another transmitting terminal device.

In one embodiment, the processing module is further configured to:
determine a transmitting time length corresponding to each ranging signal and/or a time interval between corresponding transmitting times of the ranging signal and an adjacent ranging signal according to a protocol agreement; or
determine a transmitting time length corresponding to each ranging signal and/or a time interval between corresponding transmitting times of the ranging signal and an adjacent ranging signal based on pre-configured information; or
determine a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the processing module is further configured to:
determine the value of k according to a protocol agreement; or
determine the value of k based on pre-configured information; or
determine the value of k based on received configuration information and/or indication information in downlink control information transmitted by a network device; or
determine the value of k based on a QoS requirement of a ranging or positioning service.

In a fourth aspect, an embodiment of the present disclosure provides a communication apparatus. On a receiving terminal device side, the apparatus includes:
a transceiver module, configured to receive, in k times, k ranging signals transmitted by a transmitting terminal device, where the k ranging signals respectively occupy different subband groups, each subband group contains an integer number of subbands, each subband contains a continuous frequency domain resource, and k is an integer greater than or equal to 1; and
a processing module, configured to range and/or position the transmitting terminal device based on the k ranging signals.

In one embodiment, the processing module is further configured to:
determine the number of frequency domain units contained in each subband and/or a frequency domain position of the subband according to a protocol agreement; or
determine the number of frequency domain units contained in each subband and/or a frequency domain position of the subband based on pre-configured information; or
determine the number of frequency domain units contained in each subband and/or a frequency domain position of the subband based on received configuration information and/or indication information in downlink control information transmitted by a network device,
where frequency domain units between different subbands do not overlap each other.

In one embodiment, the processing module is further configured to:
determine a frequency domain bandwidth available for the ranging signals;
determine the number M of subbands; and
divide the frequency domain bandwidth available for the ranging signals into non-overlapping M continuous frequency domain resources, each of which is one subband.

In one embodiment, the processing module is configured to:
determine the frequency domain bandwidth available for the ranging signals according to a protocol agreement; or
determine the frequency domain bandwidth available for the ranging signals based on pre-configured information; or
determine the frequency domain bandwidth available for the ranging signals based on received configuration information and/or indication information in downlink control information transmitted by a network device.

In one embodiment, the processing module is configured to:
determine the number M of the subbands according to a protocol agreement; or
determine the number M of the subbands based on pre-configured information; or
determine the number M of the subbands based on received configuration information and/or indication information in downlink control information transmitted by a network device.

In one embodiment, the processing module is further configured to:
in response to (L/M) being an integer, determine that the size of the subband is (L/M) frequency domain units; or
in response to (L/M) being a non-integer, determine that the size of each of x subbands is rounded up (L/M) frequency domain units, and the size of each of the remaining subbands is rounded down (L/M) frequency domain units, where x is the remainder of (L/M); or
in response to (L/M) being a non-integer, determine that the size of each of M−1 subbands is rounded up (L/M) frequency domain units, and the size of one remaining subband is the number of remaining frequency domain units in L frequency domain units,
where the available frequency domain bandwidth includes the L frequency domain units.

In one embodiment, the union of subband groups respectively occupied by the k ranging signals is equal to a frequency domain bandwidth available for all ranging signals.

In one embodiment, the processing module is further configured to:
determine the number of subbands contained in each subband group according to a protocol agreement; or
determine the number of subbands contained in each subband group based on pre-configured information; or
determine the number of subbands contained in each subband group based on received configuration information and/or indication information in downlink control information transmitted by a network device; or
determine the number of subbands contained in each subband group based on a QoS requirement of a ranging or positioning service.

In one embodiment, the subband groups meet at least one of:
different subband groups contain a same number of subbands;
the subbands contained in the subband groups are continuous subbands; and
the subband groups are comb-distributed in the frequency domain bandwidth available for the ranging signals.

In one embodiment, the processing module is further configured to:
determine a frequency domain position of the subband group corresponding to one of the ranging signals.

In one embodiment, the processing module is further configured to:
determine the frequency domain position of the subband group corresponding to the ranging signal based on the order of the ranging signal in the k ranging signals and a first offset; or
determine the frequency domain position of the subband group corresponding to the ranging signal based on a transmitting time position corresponding to the ranging signal and a second offset; or
determine the frequency domain position of the subband group corresponding to the ranging signal according to a protocol agreement; or
determine the frequency domain position of the subband group corresponding to the ranging signal based on pre-configured information; or
determine the frequency domain position of the subband group corresponding to the ranging signal based on an indication of a network device.

In one embodiment, the processing module is further configured to:
determine the first offset and/or the second offset according to a protocol agreement; or
determine the first offset and/or the second offset based on pre-configured information; or
determine the first offset and/or the second offset based on an indication of a network device; or
determine the first offset and/or the second offset based on a total frequency domain bandwidth available for the ranging signals.

In one embodiment, the processing module is further configured to:
determine a transmitting time length corresponding to each ranging signal and/or a time interval between corresponding transmitting times of the ranging signal and an adjacent ranging signal according to a protocol agreement; or
determine a transmitting time length corresponding to each ranging signal and/or a time interval between corresponding transmitting times of the ranging signal and an adjacent ranging signal based on pre-configured information; or
determine a transmitting time length corresponding to each ranging signal and/or a time interval between corresponding transmitting times of the ranging signal and an adjacent ranging signal based on received configuration information and/or indication information in downlink control information transmitted by a network device.

In one embodiment, the processing module is further configured to:
determine the value of k according to a protocol agreement; or
determine the value of k based on pre-configured information; or
determine the value of k based on received configuration information and/or indication information in downlink control information transmitted by a network device; or
determine the value of k based on a QoS requirement of a ranging or positioning service.

In a fifth aspect, an embodiment of the present disclosure provides a communication apparatus. The communication apparatus includes one or more processors. When calling a computer program in a memory, the one or more processors performs the method according to the above first aspect.

In a sixth aspect, an embodiment of the present disclosure provides a communication apparatus. The communication apparatus includes one or more processors. When calling a computer program in a memory, the one or more processors performs the method according to the above second aspect.

In a seventh aspect, an embodiment of the present disclosure provides a communication apparatus. The communication apparatus includes one or more processors and a memory. The memory has a computer program stored therein. The one or more processors executes the computer program stored in the memory to cause the communication apparatus to perform the method according to the above first aspect.

In an eighth aspect, an embodiment of the present disclosure provides a communication apparatus. The communication apparatus includes one or more processors and a memory. The memory has a computer program stored therein. The one or more processors executes the computer program stored in the memory to cause the communication apparatus to perform the method according to the above second aspect.

In a ninth aspect, an embodiment of the present disclosure provides a communication apparatus. The apparatus includes one or more processors and an interface circuit. The interface circuit is configured to receive code instructions and transmit the code instructions to the one or more processors. The one or more processors is configured to run the code instructions to cause the apparatus to perform the method according to the above first aspect.

In a tenth aspect, an embodiment of the present disclosure provides a communication apparatus. The apparatus includes one or more processors and an interface circuit. The interface circuit is configured to receive code instructions and transmit the code instructions to the one or more processors. The one or more processors is configured to run the code instructions to cause the apparatus to perform the method according to the above second aspect.

In an eleventh aspect, an embodiment of the present disclosure provides a system for transmitting a sidelink ranging signal. The system includes the communication apparatus according to the third aspect and the communication apparatus according to the fourth aspect, or the system includes the communication apparatus according to the fifth aspect and the communication apparatus according to the sixth aspect, or the system includes the communication apparatus according to the seventh aspect and the communication apparatus according to the eighth aspect, or the system includes the communication apparatus according to the ninth aspect and the communication apparatus according to the tenth aspect.

In a twelfth aspect, an embodiment of the present invention provides a non-transitory computer-readable storage medium, storing instructions to be executed by the above terminal device. The instructions, when executed by the terminal device, cause the terminal device to perform the method according the above first aspect.

In a thirteenth aspect, an embodiment of the present invention provides a non-transitory readable storage medium, storing instructions to be executed by the above network device. The instructions, when executed by the above network device, cause the network device to perform the method according to the second aspect.

In a fourteenth aspect, the present disclosure further provides a computer program product including a computer program. The computer program product, when run on a computer, causes the computer to perform the method according to the first aspect.

In a fifteenth aspect, the present disclosure further provides a computer program product including a computer program. The computer program product, when run on a computer, causes the computer to perform the method according to the second aspect.

In a sixteenth aspect, the present disclosure provides a chip system. The chip system includes at least one processor and an interface, to support a terminal device in implementing the functions involved in the first aspect, for example, determining or processing at least one of data and information involved in the method above. In a possible design, the chip system further includes a memory. The memory is configured to store a computer program and data necessary for the terminal device. The chip system may consist of chips, or include chips and other discrete devices.

In a seventeenth aspect, the present disclosure provides a chip system. The chip system includes at least one processor and an interface, to support a network device in implementing the functions involved in the second aspect, for example, determining or processing at least one of data and information involved in the method above. In a possible design, the chip system further includes a memory. The memory is configured to store a computer program and data necessary for the network device. The chip system may consist of chips, or include chips and other discrete devices.

In an eighteenth aspect, the present disclosure provides a computer program. The computer program, when run on a computer, causes the computer to perform the method according to the first aspect.

In a nineteenth aspect, the present disclosure provides a computer program. The computer program, when run on a computer, causes the computer to perform the method according to the second aspect.

In the above embodiments, it may be fully or partially implemented by software, hardware, firmware, or any combination thereof. When implemented using software, it may be fully or partially implemented in the form of computer program products. The computer program products include one or more computer programs. When loading and executing the computer program on the computer, all or part of the processes or functions described in the embodiments of the present disclosure are generated. The computer may be a general-purpose computer, a dedicated computer, a computer network, or another programmable apparatus. The computer program may be stored in a computer-readable storage medium, or transmitted from one computer-readable storage medium to another. For example, the computer program may be transmitted from one website, computer, server, or data center to another site website, computer, server, or data center through wired (such as coaxial cable, fiber optic, or digital subscriber line (DSL)) or wireless (such as infrared, wireless, or microwave) methods. The computer-readable storage medium may be any available medium that a computer can access or a data storage device such as a server or data center that includes one or more available media integrated. The available medium may be a magnetic medium (such as a floppy disk, a hard disk, and a magnetic tape), an optical medium (such as a high-density digital video disc (DVD)), or a semiconductor medium (such as a solid state disk (SSD)), etc.

A person of ordinary skill in the art may understand that first, second, and other numerical numbers involved in the present disclosure are merely for the convenience of description and differentiation, but are not intended to limit the scope of the embodiments of the present disclosure, and also indicate the order.

At least one in the present disclosure may also be described as one or more, and a plurality of may be two, three, four, or more, which is not limited in the present disclosure. In the embodiments of the present disclosure, for a technical feature, technical features in such technical feature are distinguished by “first”, “second”, “third”, “A”, “B”, “C”, “D”, etc. The technical features described by “first”, “second”, “third”, “A”, “B”, “C”, and “D” do not have any order of sequence or magnitude.

The correspondences shown in each table in the present disclosure may be configured or predefined. The values of information in each table are merely examples and may be configured to other values, which is not limited in the present disclosure. When configuring the correspondence between information and parameters, it is not necessary to configure all the correspondences shown in each table. For example, in the tables in the present disclosure, the correspondences shown in certain rows may not be configured. In another example, appropriate deformation adjustments, such as splitting and merging, may be made based on the above tables. The names of the parameters shown in the titles in the above tables may also be other names understandable by the communication apparatus, and the values or representations of the parameters thereof may also be other values or representations understandable by the communication apparatus. The above tables may also be implemented using other data structures, such as arrays, queues, containers, stacks, linear tables, pointers, linked lists, trees, graphs, structures, classes, heaps, hash tables, or hash tables.

Predefined in the present disclosure may be understood as defined, pre-defined, stored, pre-stored, pre-negotiated, pre-configured, solidified, or pre-burned.

A person of ordinary skill in the art may realize that the units and algorithm steps of each example described in conjunction with the embodiments disclosed herein can be implemented in electronic hardware, or a combination of computer software and electronic hardware. Whether these functions are executed in hardware or software depends on the specific application and design constraints of the technical solution. A person skilled in the art may use different methods to implement the described functions for each specific application, but such implementation should not be considered beyond the scope of the present disclosure.

A person skilled in the art may clearly understand that for the convenience and brevity of the description, reference may be made to the corresponding processes in the above method embodiments for the specific working processes of the system, apparatus, and unit described above. Details are not repeated herein.

The above descriptions are merely specific implementations of the present disclosure, but the protection scope of the present disclosure is not limited thereto. Any modification or replacement that can be readily figured out by any person skilled in the art within the technical scope disclosed in the present disclosure shall fall within the protection scope of the present disclosure. Therefore, the protection scope of the present disclosure shall be subjected to the protection scope of the claims.

1. A method for transmitting a sidelink ranging signal, performed by a transmitting terminal device, the method comprising:
transmitting k ranging signals to a receiving terminal device in k times, wherein the k ranging signals respectively occupy different subband groups, at least one subband group contains an integer number of subbands, at least one subband contains a continuous frequency domain resource, and k is a positive integer greater than or equal to 1.

2. The method according to claim 1, further comprising:
determining a number of frequency domain units contained in the at least one subband and/or a frequency domain position of the at least one subband according to a protocol agreement; or
determining a number of frequency domain units contained in the at least one subband and/or a frequency domain position of the at least one subband based on pre-configured information; or
determining a number of frequency domain units contained in the at least one subband and/or a frequency domain position of the at least one subband based on received configuration information and/or indication information in downlink control information transmitted by a network device,
wherein frequency domain units between different subbands do not overlap each other.

3. The method according to claim 1, further comprising:
determining a frequency domain bandwidth available for the ranging signals;
determining a number M of subbands; and
dividing the frequency domain bandwidth available for the ranging signals into non-overlapping M continuous frequency domain resources, each of which is one subband.

4. The method according to claim 3, wherein determining the frequency domain bandwidth available for the ranging signals comprises:
determining the frequency domain bandwidth available for the ranging signals according to a protocol agreement; or
determining the frequency domain bandwidth available for the ranging signals based on pre-configured information; or
determining the frequency domain bandwidth available for the ranging signals based on received configuration information and/or indication information in downlink control information transmitted by a network device.

5. The method according to claim 3, wherein determining the number M of subbands comprises:
determining the number M of the subbands according to a protocol agreement; or
determining the number M of the subbands based on pre-configured information; or
determining the number M of the subbands based on received configuration information and/or indication information in downlink control information transmitted by a network device.

6. The method according to claim 3, further comprising:
in response to (L/M) being an integer, determining that a size of the subband is (L/M) frequency domain units; or
in response to (L/M) being a non-integer, determining that a size of each of x subbands is rounded up (L/M) frequency domain units, and a size of each of the remaining subbands is rounded down (L/M) frequency domain units, wherein x is the remainder of (L/M); or
in response to (L/M) being a non-integer, determining that a size of each of M−1 subbands is rounded up (L/M) frequency domain units, and a size of one remaining subband is the number of remaining frequency domain units in L frequency domain units,
wherein the available frequency domain bandwidth comprises the L frequency domain units.

7. (canceled)

8. The method according to claim 1, further comprising:
determining at least one of according to a protocol agreement: a number of subbands contained in the at least one subband group; a transmitting time length corresponding to at least one ranging signal; a time interval between corresponding transmitting times of the at least one ranging signal and an adjacent ranging signal; a value of k; or
determining at least one of based on pre-configured information: a number of subbands contained in the at least one subband group; a transmitting time length corresponding to at least one ranging signal; a time interval between corresponding transmitting times of the at least one ranging signal and an adjacent ranging signal; a value of k; or
determining at least one of based on received configuration information and/or indication information in downlink control information transmitted by a network device: a number of subbands contained in the at least one subband group; a transmitting time length corresponding to at least one ranging signal; a time interval between corresponding transmitting times of the at least one ranging signal and an adjacent ranging signal; a value of k; or
determining at least one of based on a Quality of Service (QOS) requirement of a ranging or positioning service: a number of subbands contained in the at least one subband group;
a value of k.

9. The method according to claim 1, wherein the subband groups meet at least one of the following:
different subband groups contain a same number of subbands;
the subbands contained in the subband groups are continuous subbands; or
the subband groups are comb-distributed in a frequency domain bandwidth available for the ranging signals.

10. The method according to claim 1, further comprising:
determining a frequency domain position of a subband group corresponding to one of the k ranging signals, wherein determining the frequency domain position of the subband group corresponding to one of the k ranging signals comprises:
determining the frequency domain position of the subband group corresponding to the ranging signal based on an order of the ranging signal in the k ranging signals and a first offset; or
determining the frequency domain position of the subband group corresponding to the ranging signal based on a transmitting time position corresponding to the ranging signal and a second offset; or
determining the frequency domain position of the subband group corresponding to the ranging signal according to a protocol agreement; or
determining the frequency domain position of the subband group corresponding to the ranging signal based on pre-configured information; or
determining the frequency domain position of the subband group corresponding to the ranging signal based on an indication of a network device.

11-12. (canceled)

13. The method according to claim 1, further comprising:
processing the ranging signals based on a sequence or cyclic shift different from that of another transmitting terminal device, wherein a ranging signal transmitted by the transmitting terminal device occupies the same subband group as a ranging signal transmitted by the another transmitting terminal device.

14-15. (canceled)

16. A method for transmitting a sidelink ranging signal, performed by a receiving terminal device, wherein the method comprises:
receiving, in k times, k ranging signals transmitted by a transmitting terminal device, wherein the k ranging signals respectively occupy different subband groups, at least one subband group contains an integer number of subbands, at least one subband contains a continuous frequency domain resource, and k is an integer greater than or equal to 1; and
ranging and/or positioning the transmitting terminal device based on the k ranging signals.

17. The method according to claim 16, further comprising:
determining a number of frequency domain units contained in at least one subband and/or a frequency domain position of the at least one subband according to a protocol agreement; or
determining a number of frequency domain units contained in at least one subband and/or a frequency domain position of the at least one subband based on pre-configured information; or
determining a number of frequency domain units contained in at least one subband and/or a frequency domain position of the at least one subband based on received configuration information and/or indication information in downlink control information transmitted by a network device,
wherein frequency domain units between different subbands do not overlap each other.

18. The method according to claim 16, further comprising:
determining a frequency domain bandwidth available for the ranging signals;
determining a number M of subbands; and
dividing the frequency domain bandwidth available for the ranging signals into non-overlapping M continuous frequency domain resources, each of which is one subband.

19. The method according to claim 18, wherein determining the frequency domain bandwidth available for the ranging signals comprises:
determining the frequency domain bandwidth available for the ranging signals according to a protocol agreement; or
determining the frequency domain bandwidth available for the ranging signals based on pre-configured information; or
determining the frequency domain bandwidth available for the ranging signals based on received configuration information and/or indication information in downlink control information transmitted by a network device.

20. The method according to claim 18, wherein determining the number M of subbands comprises:
determining the number M of the subbands according to a protocol agreement; or
determining the number M of the subbands based on pre-configured information; or
determining the number M of the subbands based on received configuration information and/or indication information in downlink control information transmitted by a network device.

21. The method according to claim 18, further comprising:
in response to (L/M) being an integer, determining that a size of the subband is (L/M) frequency domain units; or
in response to (L/M) being a non-integer, determining that a size of each of x subbands is rounded up (L/M) frequency domain units, and a size of each of the remaining subbands is rounded down (L/M) frequency domain units, wherein x is the remainder of (L/M); or
in response to (L/M) being a non-integer, determining that a size of each of M−1 subbands is rounded up (L/M) frequency domain units, and a size of one remaining subband is the number of remaining frequency domain units in L frequency domain units,
wherein the available frequency domain bandwidth comprises the L frequency domain units.

22. (canceled)

23. The method according to claim 16, further comprising:
determining at least one of according to a protocol agreement: a number of subbands contained in the at least one subband group; a transmitting time length corresponding to at least one ranging signal; a time interval between corresponding transmitting times of the at least one ranging signal and an adjacent ranging signal; a value of k; or
determining at least one of based on pre-configured information: a number of subbands contained in the at least one subband group; a transmitting time length corresponding to at least one ranging signal; a time interval between the corresponding transmitting times of the at least one ranging signal and an adjacent ranging signal; a value of k; or
determining at least one of based on received configuration information and/or indication information in downlink control information transmitted by a network device: a number of subbands contained in the at least one subband group; a transmitting time length corresponding to at least one ranging signal; a time interval between the corresponding transmitting times of the at least one ranging signal and an adjacent ranging signal; a value of k; or
determining at least one of based on a Quality of Service (QOS) requirement of a ranging or positioning service: a number of subbands contained in the at least one subband group; a value of k.

24. The method according to claim 16, wherein the subband groups meet at least one of the following:
different subband groups contain a same number of subbands;
the subbands contained in the subband groups are continuous subbands; or
the subband groups are comb-distributed in a frequency domain bandwidth available for the ranging signals.

25. The method according to claim 16, further comprising:
determining a frequency domain position of a subband group corresponding to one of the k ranging signals, wherein determining the frequency domain position of the subband group corresponding to one of the k ranging signals comprises:
determining the frequency domain position of the subband group corresponding to the ranging signal based on an order of the ranging signal in the k ranging signals and a first offset; or
determining the frequency domain position of the subband group corresponding to the ranging signal based on a transmitting time position corresponding to the ranging signal and a second offset; or
determining the frequency domain position of the subband group corresponding to the ranging signal according to a protocol agreement; or
determining the frequency domain position of the subband group corresponding to the ranging signal based on pre-configured information; or
determining the frequency domain position of the subband group corresponding to the ranging signal based on an indication of a network device.

26-31. (canceled)

32. A communication apparatus, comprising one or more processors and a memory, wherein the memory has a computer program stored therein; and the one or more processors executes the computer program stored in the memory to cause the communication apparatus to perform a method of: transmitting k ranging signals to a receiving terminal device in k times, wherein the k ranging signals respectively occupy different subband groups, at least one subband group contains an integer number of subbands, at least one subband contains a continuous frequency domain resource, and k is a positive integer greater than or equal to 1.

33. (canceled)
